(19) United States
(12) Patent Application Publication
(10) Pub. No.: US 2020/0223538 A1
(43) Pub. Date: Jul. 16, 2020

(54) MULTI-BLADE ROTOR SYSTEM

(71) Applicant: Bell Textron Inc., Fort Worth, TX (US)

(72) Inventors: Dakota Easley, Dallas, TX (US); John Robert Wittmaak, JR., Newark, TX (US); Matthew Edward Louis, Fort Worth, TX (US); Russell C. Peters, Fort Worth, TX (US)

(73) Assignee: Bell Textron Inc., Fort Worth, TX (US)

(21) Appl. No.: 16/249,544

(22) Filed: Jan. 16, 2019

(51) Int. Cl. B64C 27/80; B64C 29/02

(52) U.S. Cl. CPC B64C 27/80; B64C 29/02

(57) ABSTRACT

A rotor system is provided in one example embodiment and may include a first pair of rotor blades comprising a first pitch and a first diameter; and a second pair of rotor blades comprising a second pitch and a second diameter, wherein the first pitch of the first pair of rotor blades and the second pitch of the second pair of rotor blades are different.

### TECHNICAL FIELD

This disclosure relates in general to the field of aircraft and, more particularly, though not exclusively, to multi-blade rotor systems.

### BACKGROUND

There are numerous considerations involved in the design of aircraft, such as rotorcraft, including size, weight, power efficiency, fuel efficiency, noise, vibration, structural loads, and so forth. In many cases, however, it may be challenging to improve certain aspects of an aircraft without disrupting other aspects. For example, rotor blade designs for aircraft rotor systems can implicate numerous performance considerations and is often an extremely challenging aspect of aircraft design.

### SUMMARY

According to one aspect of the present disclosure, a rotor system may be provided and may include a first pair of rotor blades comprising a first pitch and a first diameter; and a second pair of rotor blades comprising a second pitch and a second diameter, wherein the first pitch of the first pair of rotor blades and the second pitch of the second pair of rotor blades are different.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements.

FIGS. 1A-1B are simplified diagrams of an example aircraft, in accordance with certain embodiments.

FIGS. 2A-2E are simplified diagrams illustrating example details that may be associated with a multi-blade rotor system, in accordance with certain embodiments.

FIG. 3 is a simplified side view diagram illustrating other example details that may be associated another multi-blade rotor system, in accordance with certain embodiments.

FIGS. 4A-4B are simplified top view diagrams illustrating yet other example details that may be associated with multi-blade rotor systems, in accordance with certain embodiments.

FIG. 5 is a simplified top view diagram illustrating yet other example details that may be associated with another multi-blade rotor system, in accordance with certain embodiments.

FIG. 6 is a graph illustrating thrust comparisons between two example multi-blade rotor systems, in accordance with certain embodiments.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as ‘above’, ‘below’, ‘upper’, ‘lower’, ‘top’, ‘bottom’, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase ‘between X and Y’ represents a range that includes X and Y.

Additionally, as referred to herein in this Specification, the terms ‘forward’, ‘aft’, ‘inboard’, and ‘outboard’ may be used to describe relative relationship(s) between components and/or spatial orientation of aspect(s) of a component or components. The term ‘forward’ may refer to a spatial direction that is closer to a front of an aircraft relative to another component or component aspect(s). The term ‘aft’ may refer to a spatial direction that is closer to a rear of an aircraft relative to another component or component aspect(s). The term ‘inboard’ may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term ‘outboard’ may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

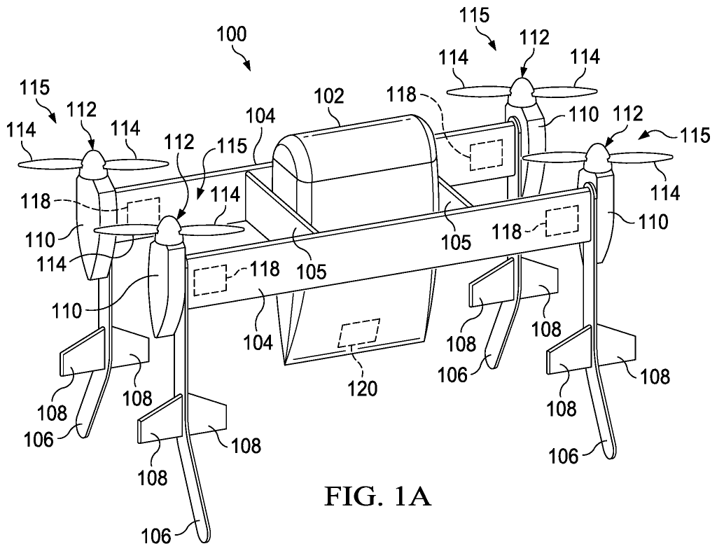

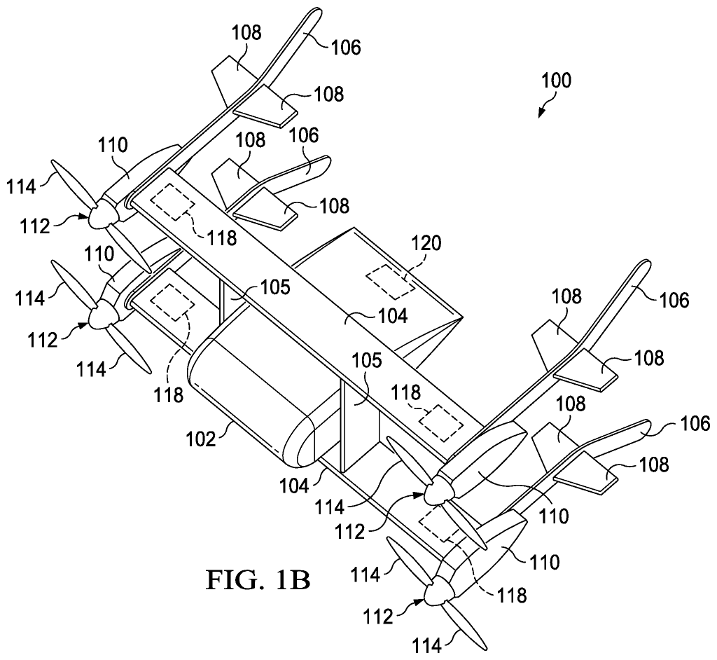

Referring now to FIGS. 1A-1B, FIGS. 1A-1B illustrate example embodiments of an example aircraft 100, which in these examples is generally configured as a vertical takeoff and landing (VTOL) aircraft. More specifically, aircraft 100 may be an autonomous pod transport (APT) convertible drone-type aircraft (discussed in further detail below) that is operable in different flight modes including a helicopter mode (as shown in FIG. 1A) and an airplane mode (as shown in FIG. 1B). Within helicopter mode, aircraft 100 may be capable of various flight maneuvers including, but not limited to, vertical takeoff from and landing to one or more landing zone(s), hover, and/or sideward and rearward mobility or flight. Within airplane mode, aircraft 100 may be capable of forward flight maneuvers. Additionally, since aircraft 100 is a convertible aircraft, it is also operable in a conversion mode when transitioning between the helicopter and airplane modes.

Unlike fixed-wing aircraft, VTOL aircraft do not require runways. Instead, VTOL aircraft are capable of taking off, hovering, and landing vertically. One example of VTOL aircraft is a helicopter, which is a rotorcraft having one or more rotors that provide vertical lift and forward thrust to the aircraft. Helicopter rotors not only enable hovering and vertical takeoff and vertical landing, but also enable forward, aftward, and lateral flight. These attributes make helicopters highly versatile for use in congested, isolated or remote areas where fixed-wing aircraft may be unable to take off and land. Helicopters, however, typically lack the forward airspeed of fixed-wing aircraft.

A tiltrotor is another example of a VTOL aircraft. Tiltrotor aircraft utilize tiltable rotor systems that may be transitioned between a forward thrust orientation and a vertical lift orientation. The rotor systems are tiltable relative to one or more fixed wings such that the associated proprotors have a generally horizontal plane of rotation for vertical takeoff, hovering, and vertical landing and a generally vertical plane of rotation for forward flight, or airplane mode, in which the fixed wing or wings provide lift. In this manner, tiltrotor aircraft combine the vertical lift capability of a helicopter with the speed and range of fixed-wing aircraft.

Yet another type of VTOL aircraft is commonly referred to as a ‘tail-sitter’ aircraft. As the name implies, a tail-sitter aircraft takes off and lands on its tail, but tilts horizontally for forward flight. As illustrated in the embodiments of FIGS. 1A-1B, aircraft 100 is configured as a tail-sitter aircraft.

VTOL aircraft may be manned or unmanned. An unmanned aerial vehicle (UAV), also commonly referred to as a ‘drone’, is an aircraft without a human pilot aboard. UAVs may be used to perform a variety of tasks, including filming, package delivery, surveillance, and other applications. A UAV typically forms a part of an unmanned aircraft system (UAS) that includes the UAV, a ground-based controller, and a system of communication between the vehicle and controller. Being a drone-type aircraft, aircraft 100 is configured for remote control and operation. Additionally, at least in some embodiments, aircraft 100 may be fully autonomous and self-directed via a predetermined or preprogrammed location-based guidance system (e.g., global positioning system (GPS), coordinate-based location, street address, etc.).

In at least one embodiment, aircraft 100 may include a cargo pod 102 that functions as the fuselage, wings 104, vertical supports 105 disposed between the wings 104, tail booms 106, horizontal stabilizers 108 extending from each tail boom 106, and a plurality of pylons 110 each comprising a rotor system 112 having a plurality of rotor blades 114. Each combination of a pylon 110 and its associated rotor system 112 comprising rotor blades 114 may be referred to herein as a propulsion assembly 115. Aircraft 100 may also include plurality of aircraft sensors 118 and a control system 120. Wings 104 comprise a substantially parallel, double-wing (sometimes referred to as ‘biplane’) configuration that provides lift to the aircraft 100 during forward flight (e.g., as shown in FIG. 1B) while also maintaining a smaller footprint of the aircraft 100 when the aircraft 100 is on the ground. Vertical supports 105 are disposed on each side of the cargo pod 102 and affixed between the wings 104 to provide structure and support to the wings 104. The cargo pod 102 is generally positioned between the wings 104 and the vertical supports 105. In the embodiment shown, the cargo pod 102 is affixed to the vertical supports 105. However, in other embodiments, the cargo pod 102 may be affixed to the wings 104 or both the wings 104 and vertical supports 105. Additionally, while two vertical supports 105 are shown, in some embodiments, aircraft 100 may comprise more vertical supports 105 depending on the configuration of the aircraft 100.

Tail booms 106 are disposed on the outboard ends of each wing 104. The tail booms 106 are curved at the aft ends to provide stabilization to the aircraft 100 during forward flight in a manner substantially similar as other tail surfaces known in the art, while also doubling as a landing gear for the aircraft 100. As such the curved ends of the tail booms 106 may provide a wider base for landing gear uses. Each tail boom 106 also comprises a pair of horizontal stabilizers 108 coupled to each of an inner and outer surface of the tail boom 106. The horizontal stabilizers 108 function to provide stabilization to the aircraft 100 during forward flight in a manner substantially similar as horizontal stabilizers known in the art. Pylons 110 are disposed on outboard sides of each tail boom 106 proximate the outboard end of each wing 104. Each pylon 110 comprises a selectively rotatable rotor system 112 having a plurality of rotor blades 114 coupled thereto. In the embodiment shown, each rotor system 112 is driven by an associated electric motor (not shown) within each pylon 110. However, in other embodiments, the rotor systems 112 may be driven by a combustion engines or auxiliary power unit through a plurality of interconnect driveshafts and/or auxiliary gearboxes, which may be housed within any portion of an aircraft (e.g., within a pylon, fuselage, combinations thereof, or the like). Furthermore, since aircraft 100 functions as a convertible aircraft, the rotational speeds of each rotor system 112 may be selectively controlled to orient aircraft 100 in the various flight modes.

In various embodiments, control system 120 may include one or more processor(s), memory element(s), network connectivity device(s), storage, input/output (I/O) device(s), combinations thereof, or the like to facilitate operations of each propulsion assembly 115 and/or other electronic systems of aircraft 100. In various embodiments, operation of each propulsion assembly 115 may include controlling the rotational speed of rotor systems 112, adjusting thrust vectors of rotor systems 112, and the like to facilitate vertical lift operations, forward thrust operations, transition operations, combinations thereof, or the like for aircraft 100. In some embodiments, feedback may be received by control system 120 (e.g., via each propulsion assembly 115, one or more sensors 118, etc.) to facilitate or augment various operations of aircraft 100. In various embodiments, sensors 118 may include, but not be limited to, positioning sensors, attitude sensors, speed sensors, environmental sensors, fuel sensors, temperature sensors, location sensors, combinations thereof, or the like.

When aircraft 100 is in a helicopter mode position, rotor systems 112 may provide a vertical lifting thrust for aircraft 100, which may enable hover flight operations to be performed by aircraft 100. When aircraft 100 is in an airplane mode position, rotor systems 112 may provide a forward thrust and a lifting force may be supplied by wings 104.

Some VTOL UAVs may include adjustable pitch rotor blades, which may facilitate (among other features) selective control of thrust and/or lift for the aircraft though collective pitch control (e.g., the pitch of all of the rotor blades can be adjusted in a collective manner). However, providing collective pitch control for an aircraft may impact many design considerations including increasing flight control complexity, increasing rotor system complexity, increasing cost, and/or increasing weight, among others. In contrast, fixed pitch rotor blades for VTOL UAV rotor systems may provide various advantages including decreasing flight control complexity, decreasing rotor system complexity, decreasing cost, and/or decreasing weight in comparison to adjustable pitch rotor blade systems.

Typically, fixed pitch rotor systems include a single pair of rotor blades in a propeller configuration that perform well for either hover operations or for forward flight operations, but not both. The result of such fixed pitch rotor systems is that, depending on the propeller chosen, the vehicle is only efficient in one phase or mode of flight.

In order to improve the performance of both phases of flight for a VTOL aircraft, such as aircraft 100, the present disclosure describes various embodiments in which each rotor system of an aircraft is a multi-blade rotor system including at least two pairs of rotor blades in which a first pair of rotor blades has a first pitch and a first diameter and a second pair of rotor blades has a second pitch and a second diameter. In at least one embodiment, the first pitch the first pitch of the first pair of rotor blades and the second pitch of the second pair of rotor blades is different such that one rotor blade pitch operates well for hover operations while the other rotor blade pitch operates well for forward flight operations.

In some embodiments, one or more additional pairs of rotor blades may be provided for rotor systems of an aircraft. In some embodiments, the one or more additional pairs of rotor blades may have a same or different pitch than the first and second pairs of rotor blades of the rotor system. In some embodiments, different pairs of rotor blades may have a same tip-to-tip diameter, while in other embodiments, different pairs of rotor blades may have different tip-to-tip diameters.

In some embodiments, one or more pairs of rotor blades may be configured in a same horizontal plane, while in other embodiments, one or more pairs of rotor blades may be configured in one or more different horizontal planes (e.g., rotor blade pairs may be in a ‘stacked’ configuration). Other features may be provided for rotor systems in accordance with other embodiments, as described herein.

As referred to herein, the term ‘fixed pitch’ in reference to a pair of fixed pitch rotor blades refers to a pitch that is set for the rotor blades based on fabrication of the rotor blades and is unchangeable once the blades are fabricated. However, the pitch from the root end to the tip end of a fixed pitch rotor blade, as discussed herein, may vary according to a twist distribution fabricated for the blades, as is typically understood in the art, but this twist distribution is unchangeable once the blades are fabricated. Further as referred to herein, pitch of rotor blades may be discussed in units of inches or in units of degrees (e.g., for pitch angles). Within the realm of UAVs, remote control (R/C) vehicles, or the like, rotor blade pitch for a propeller is characterized based on the distance that the propeller would travel forward in a liquid (with no slippage) for one full revolution of the propeller. For example, an 8-inch pitch blade would travel forward 8 inches in one full revolution, a 20-inch pitch blade would travel forward 20 inches in one full revolution, and so on. An 8-inch pitch rotor blade may be considered a lower pitch rotor blade (having a smaller pitch angle at the root end) as compared to a 20-inch rotor blade, which may be considered a higher pitch rotor blade (having a larger pitch angle at the root end) for the example comparison.

Example embodiments associated with providing multi-blade rotor systems are described below with more particular reference to the remaining FIGURES. It should be appreciated that example aircraft 100 of FIGS. 1A-1B is merely illustrative of a variety of aircraft in which multi-blade rotor systems may be used in accordance with embodiments of the present disclosure. Other aircraft in which multi-blade rotor systems may be used can include, for example, fixed wing airplanes, hybrid aircraft, unmanned aircraft, a variety of helicopter configurations, and drones, among other examples.

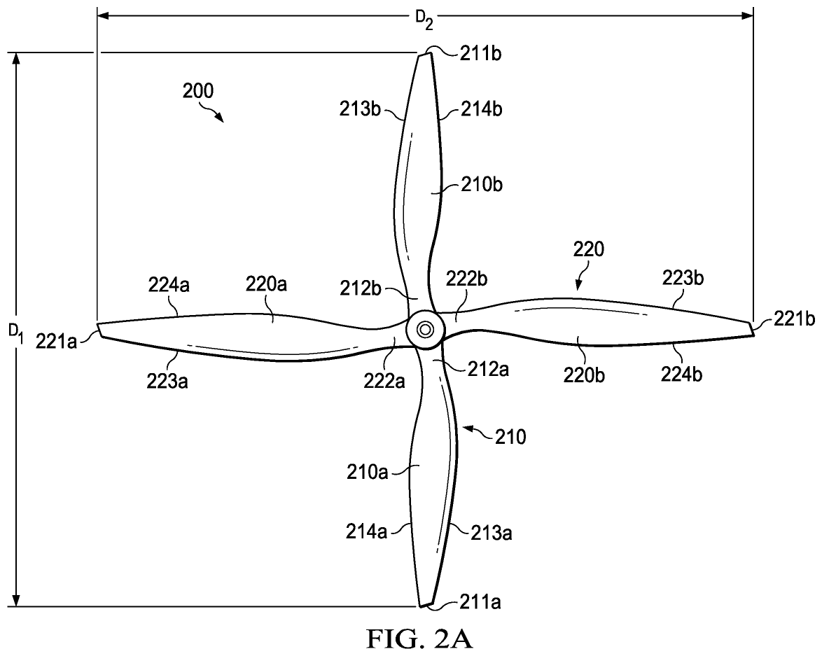

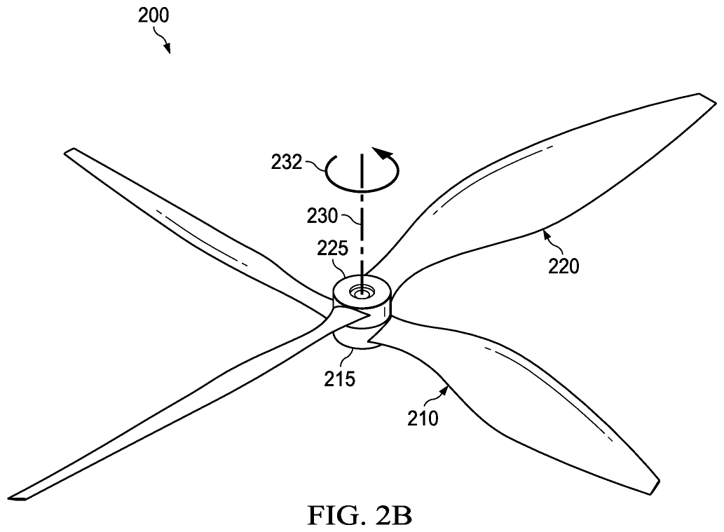

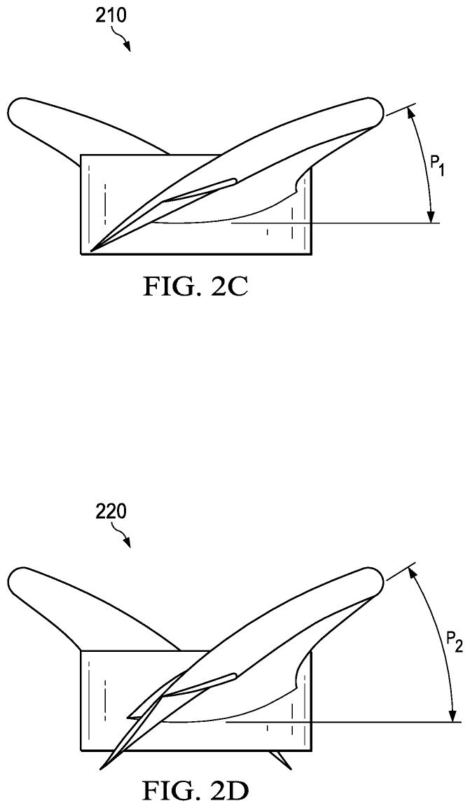

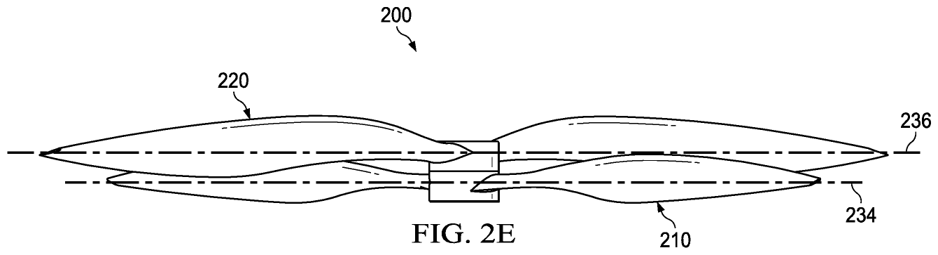

FIGS. 2A-2E are simplified diagrams illustrating example details that may be associated with a multi-blade rotor system 200, in accordance with certain embodiments. Referring to FIGS. 2A-2B, FIG. 2A is a simplified top view diagram illustrating example details that may be associated with multi-blade rotor system 200 and FIG. 2B is a simplified perspective view diagram illustrating yet other example details that may be associated with multi-blade rotor system 200, in accordance with certain embodiments.

As illustrated in FIG. 2A, multi-blade rotor system may include a first pair of rotor blades 210 and a second pair of rotor blades 220. The first pair of rotor blades 210 may include rotor blades 210a and 210b. Each respective rotor blade 210a, 210b may have a respective tip end 211a, 211b, a respective root end 212a, 212b, a respective leading edge 213a, 213b, and a respective trailing edge 214a, 214b. For the embodiments of FIGS. 2A-2E, each respective rotor blade 210a, 210b may also be attached to a first rotor hub 215 at the corresponding root end 212a, 212b of each respective rotor blade 210a, 210b. The first pair of rotor blades 210 may have a first fixed pitch P₁ (as shown at least in FIG. 2C) and a first tip-to-tip diameter D₁, as measured between the tip ends 211a, 211b of rotor blades 210a, 210b (including the diameter (not labeled) of the first rotor hub 215).

The second pair of rotor blades 220 may include rotor blades 220a and 220b. Each respective rotor blade 220a, 220b may have a respective tip end 221a, 221b, a respective root end 222a, 222b, a respective leading edge 223a, 223b, and a respective trailing edge 224a, 224b. For the embodiments of FIGS. 2A-2E, each respective rotor blade 220a, 220b may also be attached to a first rotor hub 225 at the corresponding root end 222a, 222b of each respective rotor blade 220a, 220b. The second pair of rotor blades 220 may have a second fixed pitch P₂ (as shown at least in FIG. 2D) and a first tip-to-tip diameter D₂, as measured between the tip ends 221a, 221b of rotor blades 220a, 220b (including the diameter (not labeled) of the second rotor hub 225).

The leading edge of the first and second pairs of rotor blades 210, 220 may be determined based on an axis of rotation (generally illustrated as dashed-line 230 in FIG. 2B) based on the direction that the multi-blade rotor system 200 is rotated (generally illustrated via arrow 232 in FIG. 2B) during operation (e.g., via a motor). The first and second pair of rotor blades 210, 220 may be formed of any suitable materials including, but not limited to, plastics, polymers, composite materials (e.g., carbon fiber, carbon fiber reinforced polymers (CFRPs)), metals, metal alloys, combinations thereof, or the like.

Referring to FIG. 2C, FIG. 2C is a simplified perspective view of the first pair of rotor blades 210, in accordance with certain embodiments. The second pair of rotor blades 220 of multi-blade rotor system 200 are not shown in FIG. 2C in order to illustrate other features of the first pair of rotor blades 210. FIG. 2C illustrates the first fixed pitch P₁ of the first pair of rotor blades 210.

Referring to FIG. 2D, FIG. 2D is a simplified perspective view of the second pair of rotor blades 220, in accordance with certain embodiments. The first pair of rotor blades 210 of multi-blade rotor system 200 are not shown in FIG. 2D in order to illustrate other features of the second pair of rotor blades 220. FIG. 2D illustrates the second fixed pitch P₂ of the second pair of rotor blades 220. For the embodiments of FIGS. 2A-2E, the first pitch P₁ is less than the second pitch P₂; thus, the first pair of rotor blades 210 having the lower pitch P₁ are better suited to provide vertical thrust for hovering flight operations while the second pair of rotor blades 220 having the higher pitch P2 are better suited to provide forward thrust for forward flight operations for a VTOL aircraft, such as aircraft 100.

Accordingly, the combination of different fixed pitch rotor blade pairs 210, 220 for multi-blade rotor system 200 in which one of the pitches provides improved hover thrust (e.g., the lower pitch P₁ for the first pair of rotor blades 210) and the other pitch provides improved forward thrust (e.g., the higher pitch P₂ for the second pair of rotor blades 220) may advantageously provide for the ability to improve flight performance across both phases of flight of a VTOL aircraft, such as aircraft 100, in comparison to a rotor system having only a single pair of fixed pitch rotor blades that are suited for only one phase of flight.

For embodiments of FIGS. 2A-2E, the first pair of rotor blades 210 and the second pair of rotor blades 220 are illustrated in a ‘stacked’ configuration. Referring to FIG. 2E, FIG. 2E is a simplified side view diagram illustrating other example details of multi-blade rotor system 200, in accordance with certain embodiments. As illustrated in FIG. 2E, the first pair of rotor blades 210 are configured in a first horizontal plane (generally illustrated as dashed-line 234) and the second pair of rotor blades 220 are configured in a second horizontal plane (generally illustrated as dashed-line 236) in which the first pair of rotor blades 210 are beneath the second pair of rotor blades 220. Thus, the pairs of rotor blades 210, 220 are considered to be in a multi-plane (non-coplanar) configuration for multi-blade rotor system 200.

In some embodiments, pairs of rotor blades for a multi-blade rotor system may be configured in a coplanar configuration in which one or more pairs of rotor blades of a multi-blade rotor system are configured in a same plane. For example, in some embodiments all pairs of rotor blades of a multi-blade rotor system may be co-planar. In still some embodiments, two or more pairs of rotor blades of a multi-blade rotor system may be co-planar while one or more pairs of additional rotor blades of the multi-blade rotor system may be non-coplanar with the first two or more pairs of rotor blades.

In some embodiments, a lower pitch pair of rotor blades may be beneath a higher pitch pair of rotor blades for a non-coplanar multi-blade rotor system (as illustrated for the embodiments of FIGS. 2A-2E); however, in other embodiments, a higher pitch pair of rotor blades may be beneath of lower pitch pair of rotor blades for a non-coplanar multi-blade rotor system. Thus, any configuration of stacked pairs of rotor blades may be provided for a multi-blade rotor system, in accordance with embodiments described herein. Different tradeoffs, advantages, etc. (e.g., decreased noise, decreased vibration, increased performance at certain altitudes, increased performance in certain environmental conditions, different configurations for different types of aircraft, different configurations for different propulsion assemblies, etc.) may be realized for different coplanar or non-coplanar configurations of multi-blade rotor systems and may be varied according to different design considerations, in accordance with embodiments of the present disclosure.

Further for the embodiments of FIGS. 2A-2E, the first pair of rotor blades 210 are attached to the first rotor hub 215 (shown at least in FIG. 2B) and the second pair of rotor blades 220 are attached to the second rotor hub 225 (shown at least in FIG. 2B). In some embodiments, however, pairs of rotor blades of a multi-blade rotor system may be attached to a common rotor hub in any combination of coplanar or non-coplanar configurations.

Still further for the embodiments of FIGS. 2A-2E, the first diameter D₁ of the first pair of rotor blades 210 is different than the second diameter D₂ of the second pair of rotor blades 220. For example, the first diameter D₁ is less than the second diameter D₂ for the embodiments of FIGS. 2A-2E. However, in some embodiments, the first diameter D₁ of a first pair of rotor blades of a multi-blade rotor system and the second diameter D₂ of a second pair of rotor blades of the multi-blade rotor system may be the same. Thus, any configuration of diameters of different pairs of rotor blades may be configured for a multi-blade rotor system, in accordance with embodiments described herein. Different tradeoffs, advantages, etc. (e.g., decreased noise, decreased vibration, increased performance at certain altitudes, increased performance in certain environmental conditions, different configurations for different types of aircraft, different configurations for different propulsion assemblies, etc.) may be realized for different diameters of pairs of rotor blades of multi-blade rotor systems and may be varied according to different design considerations, in accordance with embodiments of the present disclosure.

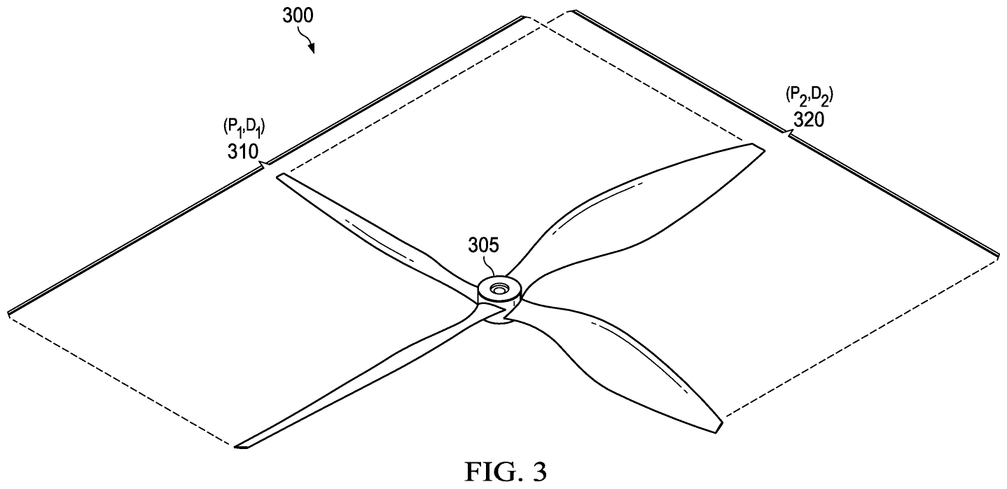

Referring to FIG. 3, FIG. 3 is a simplified perspective view diagram illustrating example details associated with another multi-blade rotor system 300, in accordance with certain embodiments. As illustrated in FIG. 3, multi-blade rotor system 300 includes a first pair of rotor blades 310 having a first fixed pitch P₁ and a first diameter D₁ (P₁, D₁) and a second pair of rotor blades 320 having a second fixed pitch P₂ and a second diameter D₂ (P₂, D₂) in which the first pitch P₁ and the second pitch P₂ are different such that one of the pitches is suited to provide improved thrust for at least one type of flight operations, conditions, etc. (e.g., hover, altitude, etc.) and the other pitch is suited to provide improved thrust for at least one other type of flight operations, conditions, etc. (e.g., forward flight, another altitude, etc.). In various embodiments, the first diameter D₁ and the second diameter D₂ may be the same or different.

The embodiment of FIG. 3 illustrates a configuration in which the different pairs of rotor blades 310, 320 of multi-blade rotor system 300 are provided in a coplanar configuration such that the root ends (not labeled) of each rotor blade of each rotor blade pair are attached to a common rotor hub 305 of the multi-blade rotor system 300. Thus, any configuration of coplanar pairs of rotor blades, non-coplanar pairs of rotor blades, and/or combinations thereof (e.g., a mixture of coplanar and non-coplanar rotor blades) may be provided for a multi-blade rotor system, in accordance with embodiments described herein. Different tradeoffs, advantages, etc. (e.g., decreased noise, decreased vibration, increased performance at certain altitudes, increased performance in certain environmental conditions, different configurations for different types of aircraft, different configurations for different propulsion assemblies, etc.) may be realized for different configurations of planar pairs of rotor blades, non-coplanar pairs of rotor blades, and/or combinations thereof for multi-blade rotor systems and may be varied according to different design considerations, in accordance with embodiments of the present disclosure.

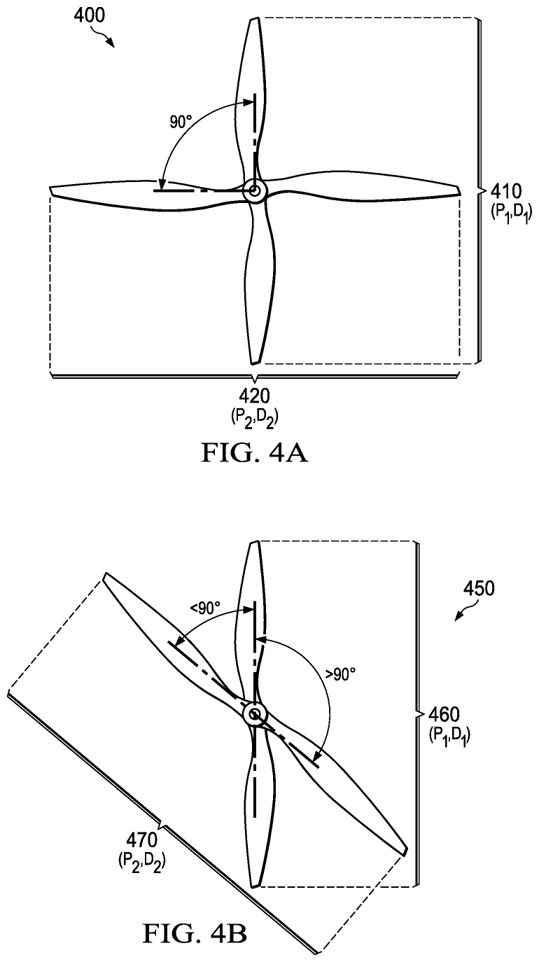

Another variation that may be configured for multi-blade rotor systems may be the angle that may be provided between each rotor blade of a particular rotor blade pair and another rotor blade of another particular rotor blade pair, as discussed below for FIGS. 4A-4B.

Referring to FIGS. 4A-4B, FIGS. 4A-4B are simplified top view diagrams illustrating yet other example details that may be associated with multi-blade rotor systems, in accordance with certain embodiments. FIG. 4A is a simplified top view diagram illustrating a multi-blade rotor system 400 including a first pair of rotor blades 410 having a first fixed pitch P₁ and a first diameter D₁ (P₁, D₁) and a second pair of rotor blades 420 having a second fixed pitch P₂ and a second diameter D₂ (P₂, D₂) in which the first pitch P₁ and the second pitch P₂ are different such that one of the pitches is suited to provide improved thrust for at least one type of flight operations, conditions, etc. and the other pitch is suited to provide improved thrust for at least one other type of flight operation, conditions, etc. For the embodiment of FIG. 4A, the each of the first pair of rotor blades 410 are 90° offset from each of the second pair of rotor blades 420.

FIG. 4B is a simplified top view diagram illustrating a multi-blade rotor system 450 including a first pair of rotor blades 460 having a first fixed pitch P₁ and a first diameter D₁ (P₁, D₁) and a second pair of rotor blades 470 having a second fixed pitch P₂ and a second diameter D₂ (P₂, D₂) in which the first pitch P₁ and the second pitch P₂ are different such that one of the pitches is suited to provide improved thrust for at least one type of flight operations, conditions, etc. and the other pitch is suited to provide improved thrust for at least one other type of flight operations, conditions, etc. For the embodiment of FIG. 4B, the each of the first pair of rotor blades 460 are at a non-90° offset from each of the second pair of rotor blades 470. For example, the offset between certain differently pitched rotor blades is greater than 90° while the offset between other differently pitched rotor blades is less than 90°.

Different tradeoffs, advantages, etc. (e.g., decreased noise, decreased vibration, increased performance at certain altitudes, increased performance in certain environmental conditions, different configurations for different types of aircraft, different configurations for different propulsion assemblies, etc.) may be realized for different offset angles between pairs of rotor blades for multi-blade rotor systems and may be varied according to different design considerations, in accordance with embodiments of the present disclosure.

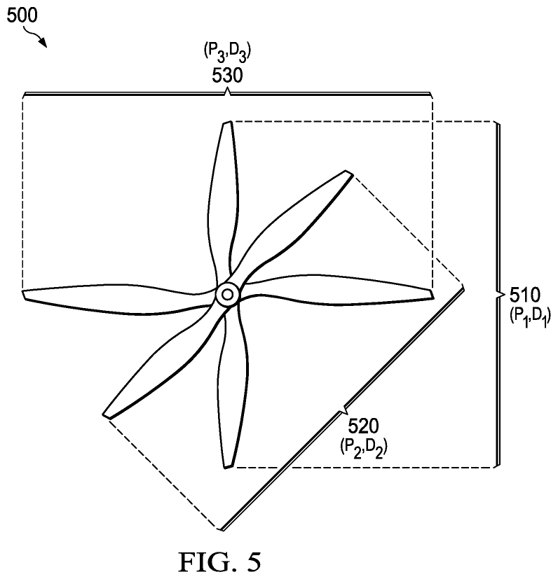

Yet another variation that may be configured for multi-blade rotor systems may be the number of pairs of differently pitched rotor blades that may be provided, as discussed below for FIG. 5.

Referring to FIG. 5, FIG. 5 is a simplified top view diagram illustrating yet other example details that may be associated with another multi-blade rotor system 500, in accordance with certain embodiments. As illustrated in FIG. 5, multi-blade rotor system 500 includes a first pair of rotor blades 510 having a first fixed pitch P₁ and a first diameter D₁ (P₁, D₁), a second pair of rotor blades 520 having a second fixed pitch P₂ and a second diameter D₂ (P₂, D₂), and a third pair of rotor blades 530 have a third fixed pitch P₃ and a third diameter D₃ (P₃, D₃). In various embodiments, any combination of the first pitch P₁, the second pitch P₂, and the third pitch P₃ may be suited to provide improved thrust for any combination of different types of flight operations, conditions, etc.

In various embodiments, a multi-blade rotor system may include two or more pairs of fixed pitch rotor blades in which at least two of the pairs of fixed pitch rotor blades have different pitches to provide improvements for different types of flight operations, conditions, etc.

As discussed for various embodiments described herein, different tradeoffs, advantages, etc. (e.g., decreased noise, decreased vibration, increased performance at certain altitudes, increased performance in certain environmental conditions, different configurations for different types of aircraft, different configurations for different propulsion assemblies, etc.) may be realized for different configurations (e.g., planar, non-coplanar, diameter, offset angle) for two or more pairs of rotor blades for multi-blade rotor systems and may be varied according to different design considerations. It is to be understood that these examples are only a few of the many different configurations that may be provided for multi-blade rotor systems, as discussed herein. Virtually any other configurations may be provided for pairs of fixed pitch rotor blades of a multi-blade rotor system and, thus, are clearly within the scope of the present disclosure.

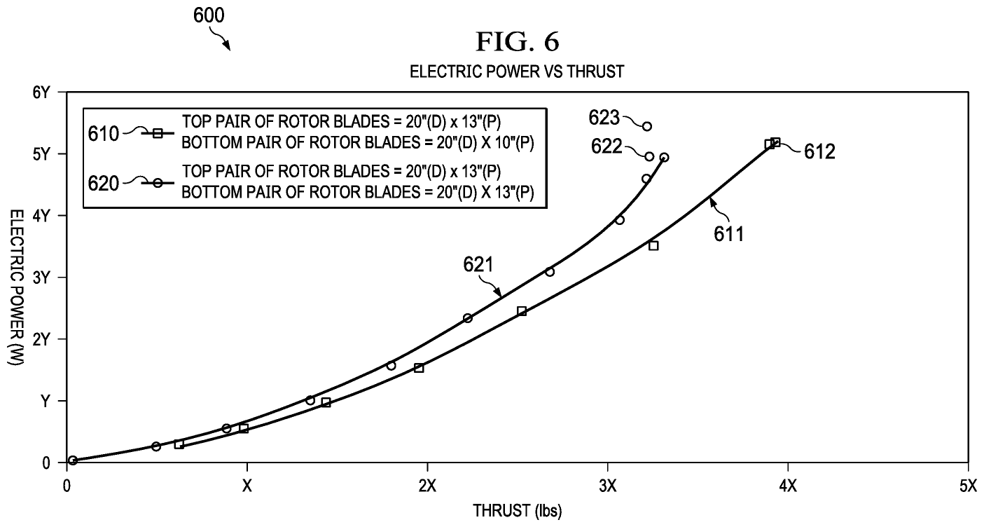

Referring to FIG. 6, FIG. 6 is a graph 600 illustrating thrust (in pounds) versus electrical power (in watts) comparisons for hovering flight operations between two multi-blade rotor systems in which each multi-blade rotor system is in a stacked, non-coplanar configuration. A first multi-blade rotor system 610 includes a top pair of rotor blades having a 20-inch diameter and a 13-inch fixed pitch (20″(D)×13″(P)) and a bottom pair of rotor blades having a 20-inch diameter and a 10-inch fixed pitch (20″(D)×10″(P)). A second rotor multi-blade system 620 includes a top pair of rotor blades and a bottom pair of rotor blades both having a same 20-inch diameter and a same 13-inch fixed pitch. In general, a lower 10-inch pitch rotor blade is better suited to provide hover thrust than a higher 13-inch pitch rotor blade. The graph 600 illustrates a first power curve 611 associated with the first multi-blade rotor system 610 and a second power curve 621 associated with the second multi-blade rotor system 620.

As illustrated in the graph 600, the second multi-blade rotor system 620 stalls at a point 622, such that increases in power do not result in increased hover (vertical) thrust but rather the thrust decreases at point 623 for the second multi-blade rotor system 620. In contrast, the power curve 611 for the first multi-blade rotor system 610 illustrates that that a higher hover thrust is achievable for higher power, as shown at point 612, based on the lower 10-inch pitch rotor blade provided for the first multi-blade rotor system. Thus, the power curve 611 illustrates that the first multi-blade rotor system 610 having one lower pitched pair of rotor blades and one higher pitched pair of rotor blades is operable to provide a higher hover thrust than the second multi-blade rotor system 620 that has two higher pitched rotor blade pairs.

As previously noted, in certain embodiments described herein, rotor blades of differing pitch are selected, such that a first pair of rotor blades has a first pitch and a first diameter and a second pair of rotor blades has a second pitch and a second diameter, wherein the first pitch is different than the second pitch such that one rotor blade pitch operates well for hover operations while the other rotor blade pitch operates well for forward flight operations.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only, and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

As used herein, unless expressly stated to the contrary, use of the phrase ‘at least one of’, ‘one or more of’ and ‘and/or’ are open ended expressions that are both conjunctive and disjunctive in operation for any combination of named elements, conditions, or activities. For example, each of the expressions ‘at least one of X, Y and Z’, ‘at least one of X, Y or Z’, ‘one or more of X, Y and Z’, ‘one or more of X, Y or Z’ and ‘A, B and/or C’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, ‘first X’ and ‘second X’ are intended to designate two X elements that are not necessarily limited by any order, rank, importance, temporal sequence, or hierarchy of the two elements. As referred to herein, ‘at least one of’, ‘one or more of’, and the like can be represented using the ‘(s)’ nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A rotor system comprising:
a first pair of rotor blades comprising a first pitch and a first diameter; and
a second pair of rotor blades comprising a second pitch and a second diameter, wherein the first pitch of the first pair of rotor blades and the second pitch of the second pair of rotor blades are different.

2. The rotor system of claim 1, wherein the first diameter of the first pair of rotor blades and the second diameter of the second pair of rotor blades are the same.

3. The rotor system of claim 1, wherein the first diameter of the first pair of rotor blades and the second diameter of the second pair of rotor blades are different.

4. The rotor system of claim 1, wherein an angle between each blade of the first pair of rotor blades and each blade of the second pair of rotor blades is ninety degrees.

5. The rotor system of claim 1, wherein an angle between each blade of the first pair of rotor blades and each blade of the second pair of rotor blades is not ninety degrees.

6. The rotor system of claim 1, wherein the first pair of rotor blades and the second pair of rotor blades are configured in the same horizontal plane.

7. The rotor system of claim 1, wherein first pair rotor blades and the second pair of rotor blades are configured in different horizontal planes.

8. The rotor system of claim 1, further comprising one or more additional pairs of rotor blades.

9. The rotor system of claim 8, wherein at least one of the one or more additional pairs of rotor blades has a pitch that is different than at least one of the first pitch of the first pair of rotor blades and the second pitch of the second pair of rotor blades.

10. The rotor system of claim 8, wherein at least of the one or more additional pairs of rotor blades has a diameter that is different than at least one of the first diameter of the first pair of rotor blades and the second diameter of the second pair of rotor blades.

11. An aircraft comprising:
a rotor system, the rotor system comprising:
a first pair of rotor blades comprising a first pitch and a first diameter; and
a second pair of rotor blades comprising a second pitch and a second diameter,
wherein the first pitch of the first pair of rotor blades and the second pitch of the second pair of rotor blades are different.

12. The aircraft of claim 11, wherein the first diameter of the first pair of rotor blades and the second diameter of the second pair of rotor blades are the same.

13. The aircraft of claim 11, wherein the first diameter of the first pair of rotor blades and the second diameter of the second pair of rotor blades are different.

14. The aircraft of claim 11, wherein an angle between each blade of the first pair of rotor blades and each blade of the second pair of rotor blades is ninety degrees.

15. The aircraft of claim 11, wherein an angle between each blade of the first pair of rotor blades and each blade of the second pair of rotor blades is not ninety degrees.

16. The aircraft of claim 11, wherein the first pair of rotor blades and the second pair of rotor blades are configured in the same horizontal plane.

17. The aircraft of claim 11, wherein first pair rotor blades and the second pair of rotor blades are configured in different horizontal planes.

18. The aircraft of claim 11, wherein the rotor system further comprises one or more additional pairs of rotor blades, and at least one of the one or more additional pairs of rotor blades has a pitch that is different than at least one of the first pitch of the first pair of rotor blades and the second pitch of the second pair of rotor blades.

19. The aircraft of claim 11, wherein the rotor system is a first rotor system, the aircraft further comprising one or more additional rotor systems.

20. The aircraft of claim 11, wherein the aircraft is configured as a vertical takeoff and landing aircraft (VTOL).
